(19) United States
(12) Patent Application Publication
(10) Pub. No.: US 2010/0064532 A1
(43) Pub. Date: Mar. 18, 2010

(54) Chain saw 3D relative positional monitoring and anti-kickback actuation system

(76) Inventors: Edward Raymond Wittke, Warwick, NY (US); Melissa Anne Wittke, Warwick, NY (US)

Correspondence Address: Edward Raymond Wittke and Melissa Anne Wittke, 25 Great Hall Road, Mahwah, NJ, 07430, US

(21) Appl. No.: 12/220,255

(22) Filed: Jul. 23, 2008

Related U.S. Application Data
(60) Provisional application No. 60/962,622, filed on Jul. 31, 2007.

(51) Int. Cl. B27B 17/00; B27G 19/00

(52) U.S. Cl. 30/382; 83/13; 83/58

(57) ABSTRACT

A system effectuates increased cutting device safety through rapid detection of abrupt motion of the device, and/or the proximity of the device cutting elements in relation to its operator. An signal processor receives, generates and processes signals from multidimensional relative distances measurement module(s) and adjusts an electro-mechanical interface with the cutting device drive and/or power mechanism as well as actuators to counteract dangerous movements of the chainsaw. Distance measurement modules resident on the user may be spatially dispersed to protect multiple areas of potential interaction between device and operator. The signal processor receives and processes the sensor signals, determines motion and proximity measurements, compares the measurements to predetermined and set thresholds, and effectuates device interruption should thresholds be reached. The signal processor contains a signal processing algorithm which accounts for noise and invalid sensor measurements such as those made due to some external object physically disrupting proximity sensor-pair measurements. The system also records on nonvolatile medium chainsaw usage parameters for later diagnosis and analysis. The system also includes secondary relative distance measurement modules to be incorporated into an apparatus worn by a second party assisting the chainsaw user. The system also includes secondary accelerometers and proximity sensors as a back up measurement means.

### CROSS REFERENCE TO RELATED APPLICATION

This application claims the benefits of earlier filed provisional patent application No. 60/962,622 filed on Jul. 31, 2007.

### BACKGROUND OF THE INVENTION

1. Field of the Invention

This invention relates to the field of power cutting devices, and more particularly to chain saws utilizing distance and positional measurement systems and actuators to enhance the safety of their operation.

A chain saw is a portable power tool having a bar mounting a motor, usually a gasoline engine, and a driven endless chain bearing cutting teeth. The chain saw is a very effective and efficient device for cutting timber. Its use has grown from principally a commercial device to a somewhat standard everyday garage tool. Chain saws today are used as cutting tools for a variety of purposes, situations, and environments—from tree cutting to statue carving. Behind their usefulness lurks a potentially-lethal side effect. Talk to any experienced tree service person, and he usually can relate some accident whether personal or not that he has encountered over the years.

Inherent in the expansion of its use from a commercial to household device, is a disproportionately large increase in the number of non-professional users—in other words everyday people. These people typically purchase the device at a local store, have very limited experience, and only use the device occasionally. The specialty chainsaw stores do take the time to instruct buyers on safety measures and precautions; however the lion's share of saws, are purchased in the large discount stores. Even if the user does receive proper training, the infrequency in which he typically uses the device precludes him from maintaining the proper awareness and user skills.

The Portable Power Equipment Manufacturers Association stated that industry shipments of gasoline-powered chainsaws in the year 2000 were something on the order of 2,126,680 units.

By their very nature, chain saws are very dangerous devices that cause some thousands of injuries and deaths each year. The revolving chain contains a multitude of small individual cutting teeth that easily cause unimaginable damage to the unfortunate chain saw user. Kickback, a very sudden and violent non-user initiated movement of the saw, occurs often in practice. In this situation the saw surges in a particular direction with an extremely high acceleration and velocity which often precludes the user from having sufficient time to take proper action.

The aforementioned Association also reported that chainsaw kickback can occur in less than 0.3 seconds, whereas measured human reaction time is only 0.75 seconds. The time difference of course leaves the unfortunate operator at an extreme disadvantage. Records also show that most injuries occur during “limbing” operations, that is, during the removal of limbs from the main trunk of the tree.

There currently exist and have for some time, a number of apparatuses to increase the safety of operation of these chain saws, such as chain brakes, bar tip guides, reduced kickback guide bars, and low or reduced kickback saw chains; however statistics still reveal an inherent ineffectiveness of these solutions. Of course money is always a factor, and any additional component beyond those necessary to perform the desired operation adds further cost to the unit.

There are many types of saw chains on the market, ranging from consumer chains to professional chains; they vary in ways such as cutting teeth shape, engine and bar size and depth gauges. Consumer chains tend to be designed to minimize kickback at the expense of performance, whereas professional chains have increased performance but less kickback protection. Chainsaws are typically classified into three groups: lightweight (8-13 inches typically), mid-weight (14 to 18 inches), and the professionally-oriented heavyweight (over 18 inches). Two types of commonly available chain saw bars are laminate and solid bars.

At full motor throttle, chains can move upwards of 45 MPH (miles per hour), which equates in some cases to 600 teeth moving past a single spot per second. It is also commonly recommended to wear ear protection, as common saws produce in excess of 95 decibels of noise.

The U.S. Consumer Product Safety Commission stated back in 1979 that approximately 50,000 people required hospital treatment for injuries associated with chain saws. They went on to state that most of these accidents were caused by the operator coming into contact with moving chain saw teeth. Injuries from a chain saw are usually serious because they leave a jagged cut.

The Davis Garvin Agency, an insurance underwriter specializing in loggers insurance, in 1989 reported the average chainsaw injury requires 110 stitches and the average medical cost was $5,600.00. By today's standards this might easily equate to something closer to 12,000 dollars. There are approximately 69,000 loggers in the U.S. alone.

Protective clothing, commonly called chaps, is available, but here again the effectiveness is limited, and doesn't do what an operator would optimally want—prevent the spinning chain from even touching his body in the first place.

Standard on many newer saws is an automatic engine cutoff mechanism activated by depression of a secondary physical lever attached to the saw. (See FIG. 3 of the drawings.) As the saw rotates backwards, the users arm causes the lever to be depressed and the engine to be cut off. This mechanism while useful does not totally eliminate nor address the dangers associated with all of the situations and scenarios in which chain saw might be used. Thus while the mechanism does undoubtedly increase the safety of the saw, it does not sufficiently protect the user against all of the possible dangerous conditions which may and do commonly occur. For example, a user may have his hands positioned in such a way that they do not engage the protective bar as the chain saw swings back at them. Also a user occasionally will use a single arm to reach a cutting target or may impact their body with the saw through unintentional slow movement of the saw (i.e. they forget where the saw is and accidentally contact their body with the saw). Thus there exists a rapid and very violent kickback type danger and secondly the slower speed accidental impact of the saw with the user type accidents.

Actuators have been in existence for many years. They come in many forms and structures and perform a variety of functions. A simple analogy would be the piston of the everyday car. When the fuel is ignited the center portion of the piston moves in one direction. This movement when coupled to the transmission causes the car to move forward. Actuators are also found on rooftops of large buildings to counteract the forces of nature. As the wind blows in one direction large actuators move in the opposite direction to counteract say the effects of wind on the building. Imagine leaning backwards and a mechanical structure pushes you forward. In chainsaws kickback as mentioned previously can be very fast and very violent. The chainsaw bar with the extremely fast rotating chain can literally swing back at your head at speeds too fast for a human operator to react to safely. Actuators can be used to counteract the forces of kickback. As the chain bar rotates backwards the actuators would fire in the opposite direction counteracting the kickback force.

Proximity sensors which measure the distance or proximity of two bodies could be used to detect the potential impact of a chainsaw with a portion of their body, however proximity sensors have a very limited range—typically no more than a few inches. There exist numerous patents regarding the use of proximity sensors with table top and circular saws commonly used on construction sites. It is questionable whether proximity sensing could effectively be used in kickback type situations where the movement of the saw is extremely rapid. Proximity sensing is more appropriately used in slow moving impact protection situations like the table top saw where users are relatively slowly pushing wood past the saw blade. It is doubtful that there would exist enough time to detect the impact of a chainsaw with a user under a violent kickback scenario. Chainsaws unlike table top saws have the added risk of impacting many parts on the user by virtue of the chainsaw device and how it used. Chainsaw accidents involve (not exclusively) impacts with the user's head, upper torso, thighs, knees, calves, feet and hands—See FIG. 1. Optimally a user might want a much greater degree of protection regarding impacts with their head in particular as well as upper torso. An impact of the chainsaw with a user's head and neck can be much more dangerous than an impact with their leg say as an example.

Radar and other distance (time) measurement techniques like optical (laser) and radio distance measurement can very accurately determine relative distances between two or more points. Radar, Radio and Optical distance measurement technology has been around for years. A Radar system emits a signal which travels through air and is reflected off of an object and returns back to the point of origin. The amount of time it takes the signal to travel to the object and back can be used to determine how far away the object is from the radar device. Consecutive radar measurements can yield velocity and acceleration measurements. In other words two back to back radar measurements can tell you how fast the object is moving towards you—think of the common police radar. With radar you can also determine where in 3D space the object is. For example, the ball is ten feet in front of you, five feet from the ground and directly in front of your left shoulder. Laser (optical) distance measurement devices also yield similar results. Some optical devices however emit a very narrow beam of light unlike a radar signal with covers a broader area. Similarly Radio signals such as those used in cellular phone transmission can be used to determine very accurately the geophysical position of a particular phone. GPS signals can be used to determine the position of a particular GPS navigation device. The point here is that with radar, radio (and other airborne signals), satellite and optical devices one can measure relative distances very accurately and with much greater range than is possible with proximity sensors. A proximity sensor can detect presence only in the range of inches whereas very large radars can detect presence and determine accurate position upwards of miles. Of course with a chainsaw you are only interested in detecting and monitoring the movement of the saw in relation to the user on the order of inches to a couple of feet. Radar like systems would allow for the monitoring of exactly where the chainsaw is in relation to the user at all times—not just seconds before impact with the use of proximity sensors and would also allow the detection of kickback—something proximity sensors most likely can protect against. The use of optical and radio distance and position measurement would also allow for the same measurements and protection.

Proximity sensing with regard to table top and circular saw typically detect the proximity of the user to the blade not to the saw housing.

By virtue of what the chainsaw does and how it is used monitoring where the chainsaw is in relation to the front rather than backside of the user is more important. With radar, radio or optical like sensing at multiple locations both on the user and the chainsaw allow for the three dimensional (3D) monitoring of the exact position of the saw in relation to the user at all times of operation. If I know where three fixed points are on a given chain saw in relation to the user's body parts and I also know the physical dimensions of all of the chainsaw parts I can very precisely determine where a point on the tip of the cutting blade is at all times.

Fatigue plays a very big part in chainsaw operation especially for professional loggers. Over the course of the standard workday how the typical user handles the saw will vary significantly. As muscles tire the typical user will becomes more lax in watching the saw use and will tend to hold the saw increasingly closer to their body. With 3D (three dimensional) monitoring of where the saw is in relation to the user such a safety system can warn the user when they become excessively lax in use.

Chainsaws typically lack the sophisticated monitoring that automobile embedded processors have today. Sensing, monitoring and recording parameters associated with the use and abuse of chainsaws can be valuable end users, manufacturers and insurance carriers. It would be useful for chainsaw embedded processors to record metrics to aid in unit diagnostics as well as accident forensics.

2. Prior Art

Numerous U.S. patents describe purely mechanical, “clothing”, like measures to enhance the protection of cutting device operators.

Stoner in U.S. Pat. No. 5,987,778 describe protective footwear and lower leg covering which may help in the prevention of injury when operating chain saws.

Foy and Tejani in U.S. Pat. No. 5,876,834 utilize a sacrificial fabric structure in their protective chain saw chaps design to offer protection to operators.

### SUMMARY OF THE INVENTION

Accordingly, it is an object of the invention to improve the safety of chain saws and the like.

A more specific object of the invention to prevent deaths, injuries and disfigurements from being incurred during the use of chain saws and the like.

Another object of the invention is to provide very accurate monitoring of the three (3) dimensional position of the chainsaw in relation to its user's body parts.

A still further object of the invention is to detect when potentially harmful operating conditions exist in terms of detecting potentially harmful chainsaw movements towards the user and/or proximity to said user.

Another object of the invention is to provide a chain saw whose cutting action is stopped whenever the saw is moved abruptly in the direction of its user.

Still another object of the invention is to provide a chain saw whose cutting action is stopped whenever the cutting teeth of the saw come close to body parts of the user.

Still another object of the invention is to provide a means of recording operation conditions such as 3D relative distances, speed and proximity between the user and the chainsaw at the time a dangerous event has occurred.

Yet another object of the invention is to provide supplemental acceleration and proximity sensing to serve as a back up to the previously mentioned 3D monitoring.

Still another object of the invention is to counteract dangerous forces/movements like those associated with kickback with opposite forces.

Still another object of the invention is to provide 3D relative distance measurement and dangerous movement monitoring in relation to persons in close proximity to chainsaw user whom are working with said user.

Yet another object of the invention is to provide a safer chain saw whose cutting effectiveness is not impaired.

A still further object of the invention is to provide a safer chain saw that is easy of manufacture and of little additional cost.

Some of the objects of the invention are achieved by an integrated, automatic, extremely-quick apparatus and method of stopping the cutting action of the chain saw in the event that the saw makes a sudden moment towards its user. To this end multidimensional distance measurement module(s) are mounted on the chainsaw. Other component multidimensional distance measurement module(s) are mounted on an apparatus worn by the user. A signal processor mounted on the chain saw generates, receives and processes the signals to determine relative distances and changes in movement between the user and the chainsaw and signals an electro-mechanical device to apply the proper electrical and/or mechanical measures to discontinue movement of the cutting endless chain and apply counter movement forces via actuators mounted on the chainsaw. Additional multidimensional distance measurement module(s) on an apparatus worn by a person not operating said chainsaw but working with said user are monitored by said signal processor.

A feature of the invention is that the above mentioned method and apparatus are completely automated—the user does not need to do anything to activate the safety mechanism.

Discontinuance of the cutting endless-chain movement may be by circuit interruption, de-clutching and/or braking operations.

The safety action of the hazardous distance safety system may be enhanced by electrically interconnecting (as by hard wiring or wireless) an array of relative distance measurement modules such that if one were to fail others would still maintain a high degree of precise chainsaw monitoring relative to the user's body.

Accordingly, it is an object of the invention to provide a means by which possibly dangerous movement of a cutting device can be detected and subsequently used to alter the operation of the device to enhance the safety of an operator.

A further object of the invention to provide a means by which the distance between a cutting device and respective operator can be monitored and utilized to ensure the safety of said operator.

A further object of the invention to provide the storage of (over time) and access to chainsaw usage parameters on nonvolatile medium such that analysis of chainsaw use and conditions might be determined at a later date.

The objects of the invention are achieved by the use of a signal processor which receives the sensor signals, determines if thresholds are exceeded and if so signals an electro-mechanical device to apply the proper electrical and/or mechanical measure to alter the operation of the cutting device. Additional accelerometers and proximity sensors are added to provide supplemental backup measurement.

Thus the device and method enables the detection of dangerous movement and proximity of cutting devices relative to the operator.

### BRIEF DESCRIPTION OF DRAWINGS OF PREFERRED EMBODIMENTS OF THE INVENTION

These and other objects, features, and advantages of the invention will become apparent from a reading of the following descriptions of preferred embodiments of the invention, when considered with the attached drawings wherein:

FIG. 1 is diagram from the U.S. Consumer Protection Safety Commission showing 1999 chain saw injury statistics in relation to locations on the body of a user;

FIG. 2 is a diagrammatic display of common chain saw components;

FIG. 3 is a pictorial representation of “Kick back”—a common industry occurrence

FIG. 4 is a diagram of chain saw related accident;

FIG. 5 is a diagram of the safety cutoff bar activation;

FIG. 6 is a diagram representing the cutoff bar engagement by means of the operator's arm;

FIG. 7 is a pictorial representation of signal triangulation—determination of where an object is in space based on distance measurement to two or more points;

FIG. 8 is a diagram similar to FIG. 7 showing signal triangulation using cellular phone signals;

FIG. 9 is a diagrammatic overview of radar and optical signal distance measurement;

FIG. 10 is a diagrammatic representation of Radio 3D signal triangulation in relation to a human user;

FIG. 11 is a diagram describing radar and optical 3D measurement in relation to a human user;

FIG. 12 is a diagrammatic side view of the chain saw, user and 3D radio signal measurement system;

FIG. 13 is a diagrammatic side view of the chain saw, user and 3D radar and optical signal measurement system;

FIG. 14 is a diagrammatic view of the chain saw with anti-kickback actuators which counters the kickback forces with actuator generated opposite forces;

FIG. 15 is a schematic diagram showing one possible orientation of radio signal receivers and transmitters, a human user and the associated chainsaw;

FIG. 16 is a schematic diagram showing one possible orientation of radar and optical signal receivers and transmitters, a human user and the associated chainsaw;

FIG. 17 is a schematic diagram showing a wired connection of radio signal receivers and transmitters to a central processing unit (CPU);

FIG. 18 is a schematic diagram showing a wired connection of radar/optical signal receivers and transmitters to a central processing unit (CPU);

FIG. 19 is a diagram showing placement of sensing elements in relation to chainsaw bar modules;

FIG. 20 shows placement of sensors encapsulated within a housing;

FIG. 21 shows sensors mounted within the bar itself;

FIG. 22 is a diagram showing the CPU interfacing to an electrical/mechanical device which connects to the chainsaw drive and engine components;

FIG. 23 shows the 3D positioning system with backup accelerometers and proximity sensors;

FIG. 24 is a diagram which represents an embodiment in which additional sensing is added to protect other people working alongside the chainsaw user;

FIG. 25 shows how a 2^{nd} party sensor outfitted user system interfaces to the CPU associated with the chainsaw being used by the operator.

### DETAILED DESCRIPTION OF AN INVENTION PREFERRED EMBODIMENT

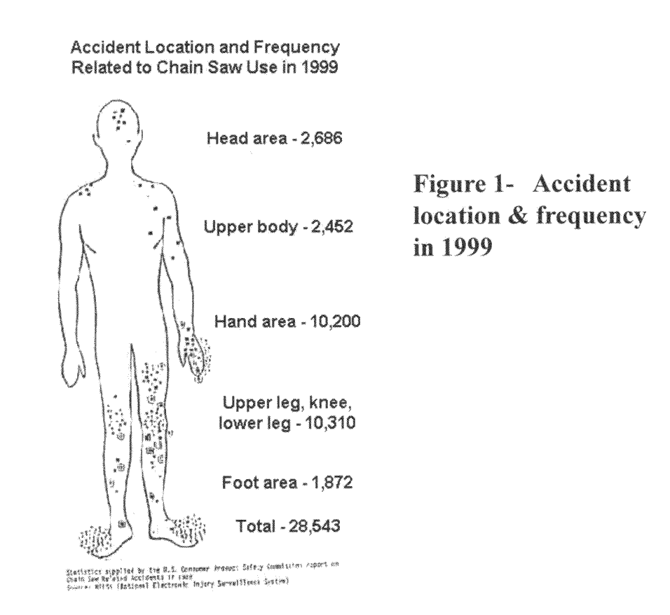

Referring now particularly to the drawings, FIG. 1 shows a summary of the 1999 US Consumer Protection Safety Commission report of 28,543 accidents related to chain saw use in the United States. It is important to note the location of injury on the body and associated frequency: 2,686 to the head, 2,452 to the upper body, 10,200 to the hands, upper leg-knee-lower leg 10,310, and 1,872 to the foot area. Though the data reflects that chain saws cause injuries throughout the body, more than 36% of them were injuries to the legs and knees.

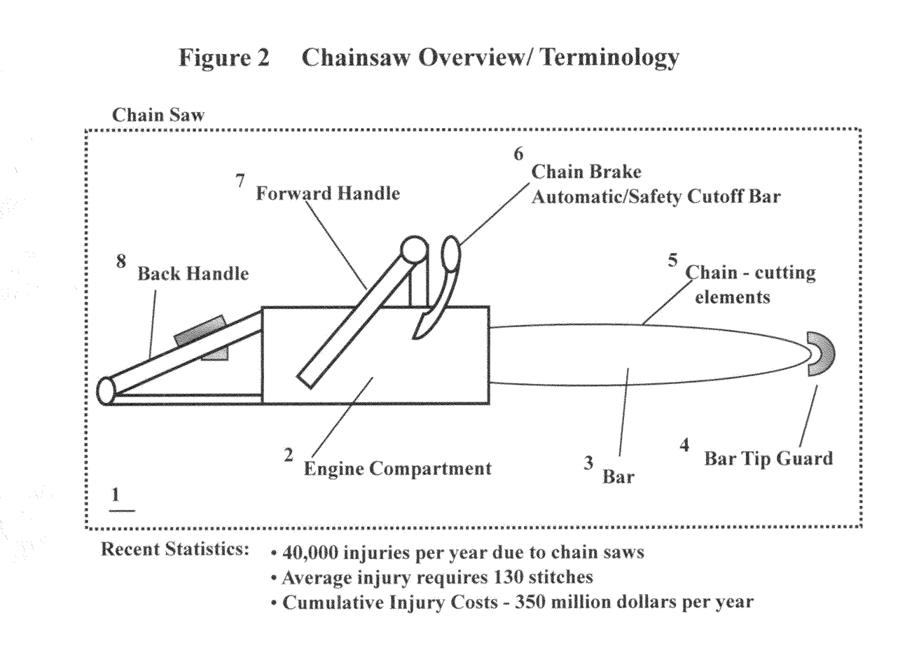

FIG. 2 shows diagrammatically typical chain saw 1 components: namely, a forward handle 7 and back handle 8 for enabling a user to grip or hold the saw, an engine compartment 2 holding a motor (typically a two-cycle gasoline engine) mounted on a bar 3, a bar tip guard 4 on the free end of the bar 3, endless-chain mounted cutting elements 5, and a chain-brake automatic/safety cutoff lever 6. These components are a representative set and not to be interpreted as all—inclusive listing. The bar tip guard 4 is a safety mechanism attached to chain saw bar 3 to prevent the teeth on the endless chain circumventing the tip, from coming into contact with any external object. The tip of the chain saw in some circumstances causes kick back.

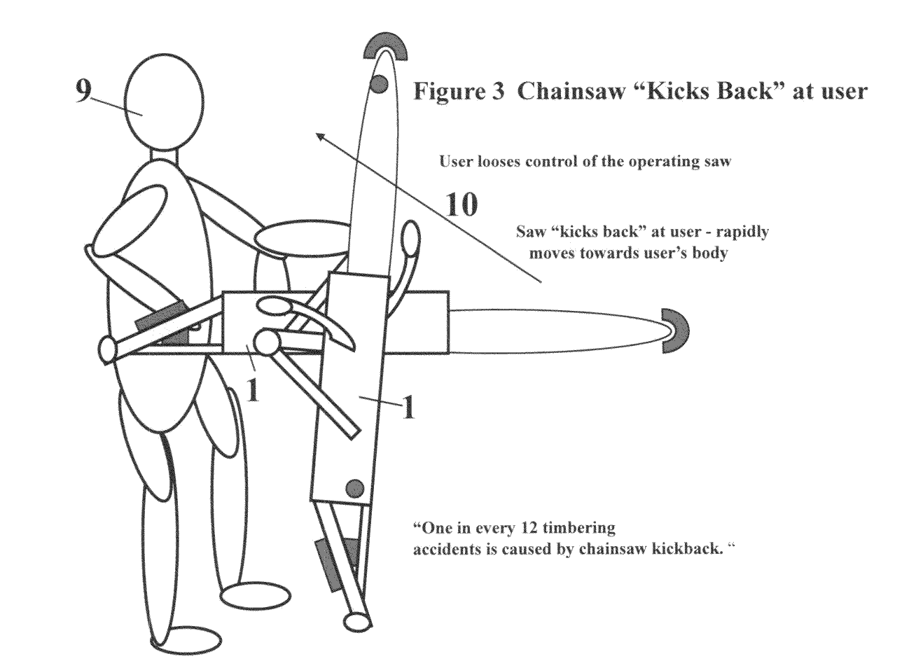

Kick back, reflected in FIG. 3 by the vertically-disposed chain saw 1, is a rapid movement 10 of the free end of chain saw 1 up towards the unknowing operator 9.

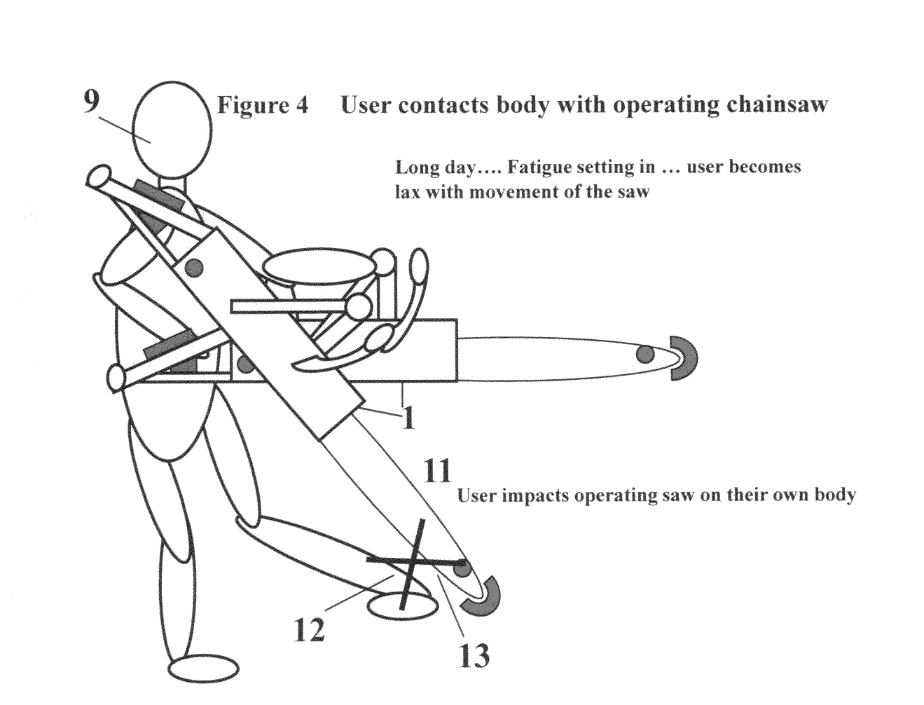

FIG. 4 shows an accident that may occur on any of a number of possible scenarios. Logging is a very physically demanding occupation in which fatigue plays a very critical role. Thus a tired logger 9 may allow the chain saw free end 13 to drop accidentally and come into contact with the lower portion 12 (leg and/or foot) of his body. The impact event of the chainsaw free end 13 with the user body part 12 is referred to as 11 in FIG. 4.

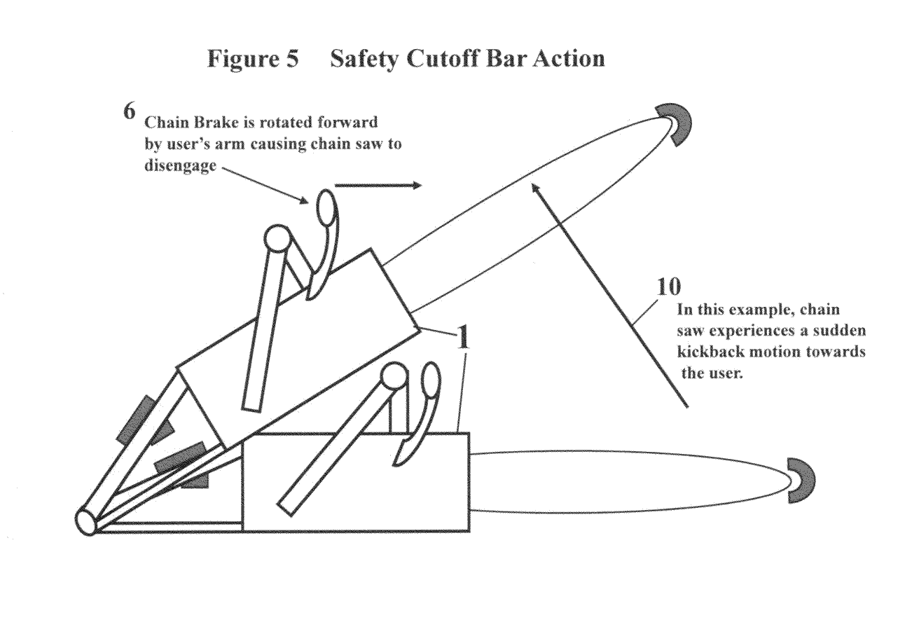

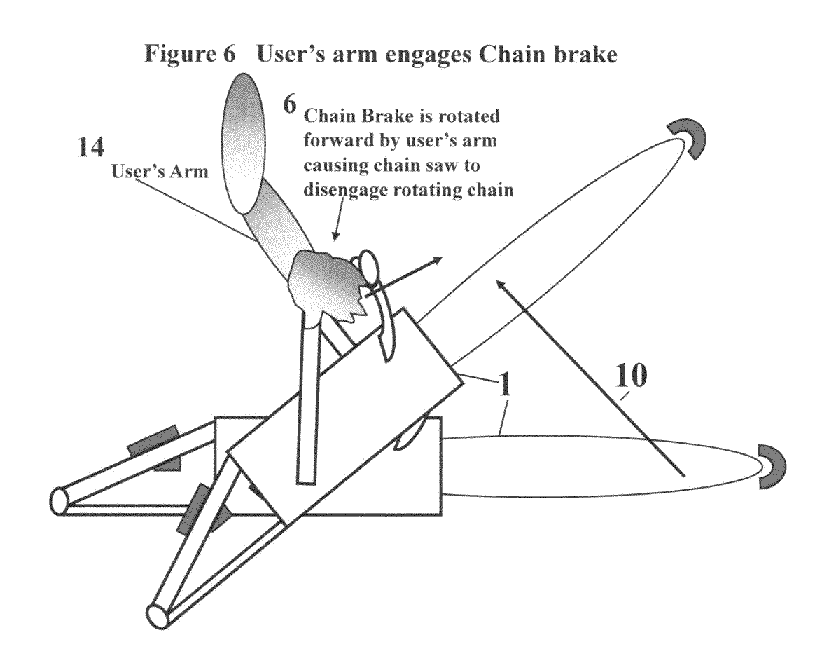

Kick back 10, depicted in an early stage in FIG. 5, typically causes upon further motion the belated engagement of the chain brake lever 6 by the operator's arm portion of his body 14, resulting in the relative forward motion of the chain brake lever 6 as shown in FIG. 6. When the chain brake lever is moved forward, the operation of the motor is interrupted. Thus should the inertia of the kicked back saw continue to carry the saw into contact with the user, injury due to revolution of the toothed endless chain will be reduced. Unfortunately, revolution of the endless chain 5 as shown in FIG. 2 is not always halted before the chain saw contacts the user on kick back, due to the belated contact of the user's arm 14 with the brake lever 6 as shown in FIG. 6.

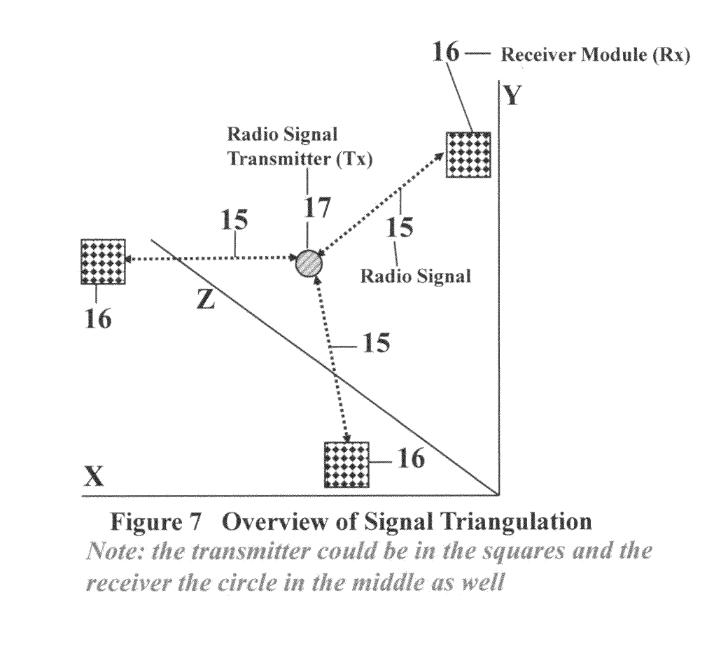

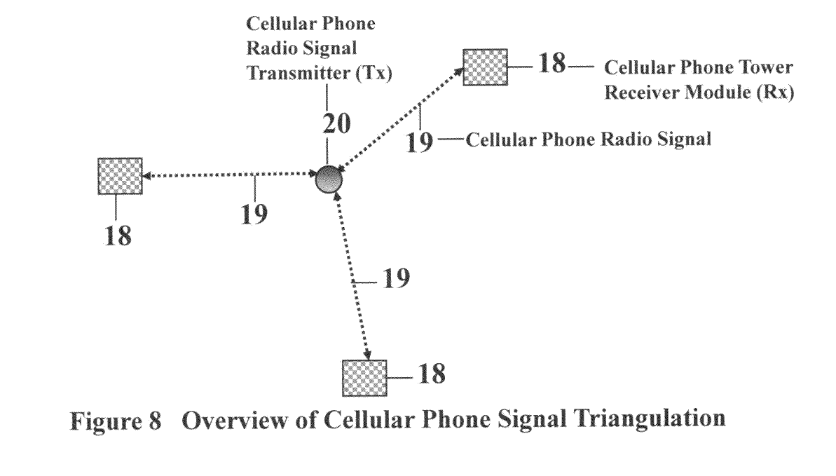

FIG. 7 introduces the concept of triangulation which is well documented. Triangulation is the process of determining the position of a subject object in space by measuring its relative distance to other objects. In some scenarios the other objects geographic positions are known allowing for geographic position determination of the subject object. What is significant here is that triangulation (i.e. distance measurement from multiple points) allows you to determine the precise position of the chain saw relative to one or more points on the chain saw user. The 3D physical layout/dimensions of the chain saw are known for a given chain saw therefore by determining where points on the chainsaw are relative to the chain saw user one can determine where chain saw parts like the spinning chain 5 are relative to the user. FIG. 7 also introduces the idea of using radio signals 15 emitted from a transmitter module 17 and received by receiver modules 16 to determine the 3D relative point in space of the transmitter module 17 relative to the receiver modules 16. Radio signal triangulation is well known and used in the cellular phone industry as outlined in FIG. 8 which is similar to FIG. 7 with the exception that in FIG. 8 the radio signal is one of those used in the cellular phone industry. Cellular phone towers both transmit and receive signals from a given cellular phone. Shown in FIG. 8 are only the tower receivers18 and cellular phone transmitters 20. As mentioned both towers and phones send and receive signals. The point of FIG. 8 is simply to remind the reader of the fact that triangulation today is used in the cellular phone industry to determine the exact geophysical position of a given cellular phone. If you know the characteristics of the signal as well as the transmission medium and the exact point in time when the signal was launched and when it was received you can determine distance. Triangulation is well documented and will not be further elaborated on herein.

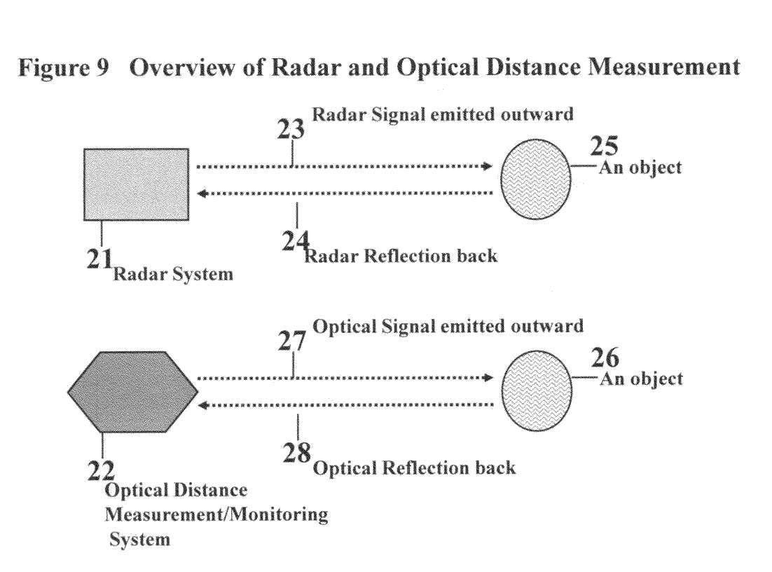

FIG. 9 introduces the concept of triangulation using radar and optical signals. Radar and optical distance measurement are well known and documented. In Radar a known signal 23 is emitted from a Radar System 21, a reflection signal 24 is returned off of an object 25 and said Radar System 21 determines both distance and speed. One single signal allows you to determine distance whereas multiple measurements allow you to determine speed and direction. Similarly an Optical System 22 emits an optical signal like a laser beam 27 which is reflected off of an object 26 and reflected signal 28 returns to the Optical System 22. Once again knowing the characteristics of the signal and the transmission medium said Optical System 22 can determine the distance, speed and direction of movement. Radar and Optical distance measurement is well documented and will not be further elaborated on herein.

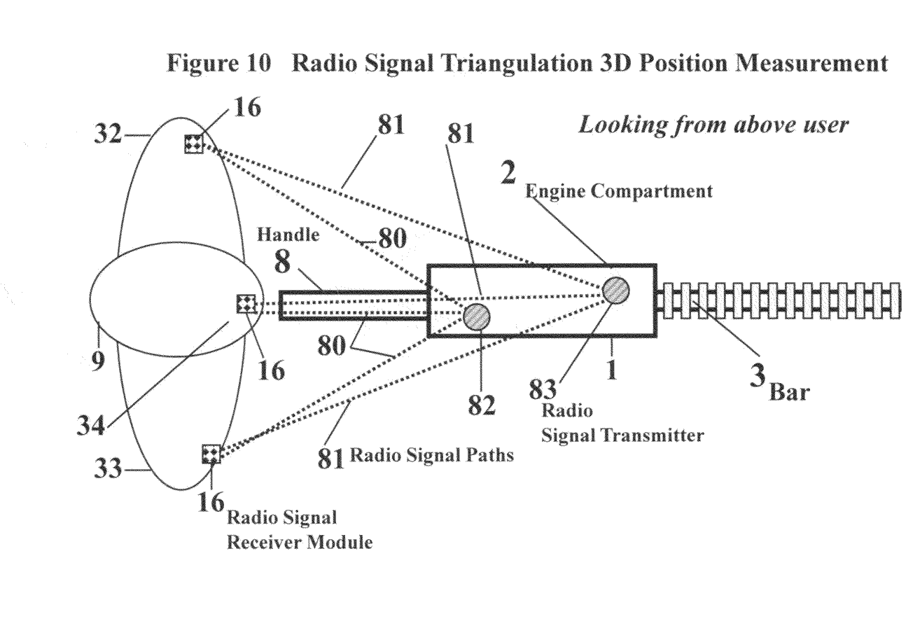

FIG. 10 shows a chain saw 1 user 9 with three radio signal receiver modules 16 mounted on the forehead of the user 34, the left shoulder of the user 32 and right shoulder of the user 33 respectfully. Two radio signal transmitters 82, 83 are mounted on the engine compartment 2 of the chain saw 1. Obviously more transmitters could be mounted on the engine compartment 2 or other parts of the chain saw 1. Likewise only one transmitter could be used as well. It is important to note that the signal characteristics of the transmitted signals 80, 81 may be different to allow for determination of receipt characteristics. For example if both 80 and 81 were transmitted at the same time and they were an identical signal then it would be unclear at the receivers 16 when each arrived—ex. which one arrived first? With triangulation there are other ways to differentiate arriving signals such as launching/sending them at different times. One could for example send signal 80 at time t0 and signal 81 at time t0+10 seconds. FIG. 10 shows one possible orientation of the user and chain saw looking from above. It is important to note that the transmitters 82, 83 could have been mounted on the user 9 and the receivers 16 on the chain saw. Also you could have a mixed configuration where some receivers where on the user and others were on the chain saw and similarly some transmitters on the chain saw and some on the user.

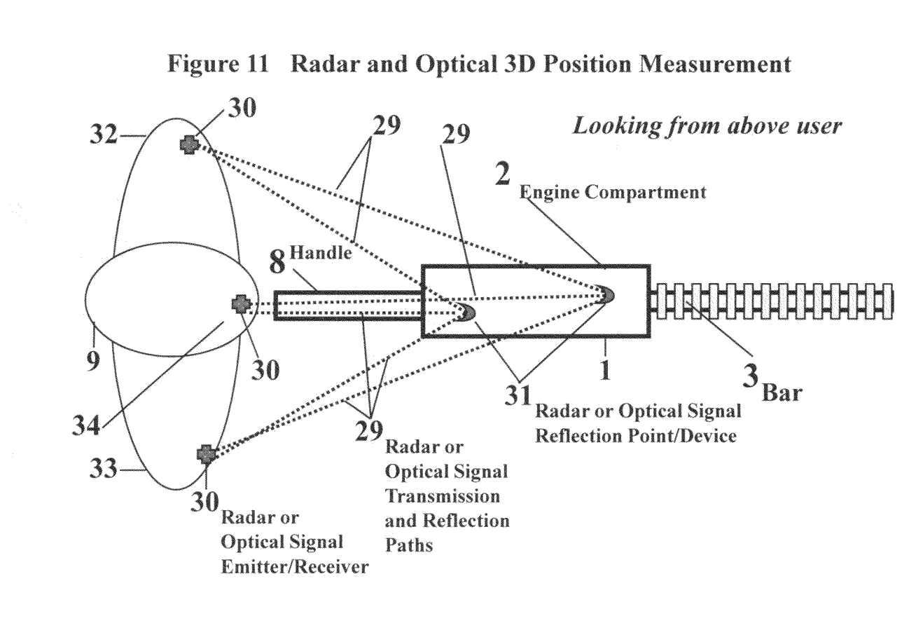

FIG. 11 similarly introduces an overhead view of a chain saw 1 user 9 with a triangulation setup but this time using radar and/or optical transmitters/receivers 30, reflectors 31 and signal transmission and reflection paths 29. The actual signals are not shown in FIG. 11 but the paths taken 29 are. Two reflection devices 31 are mounted on the engine compartment 2 of the chain saw 1. The emitter/receiver modules 30 are mounted on the user 9 forehead 34, left shoulder 32 and right shoulder 33. Note reflection devices 31 are simply icons in the figure are not meant to imply a specific size or specific orientation.

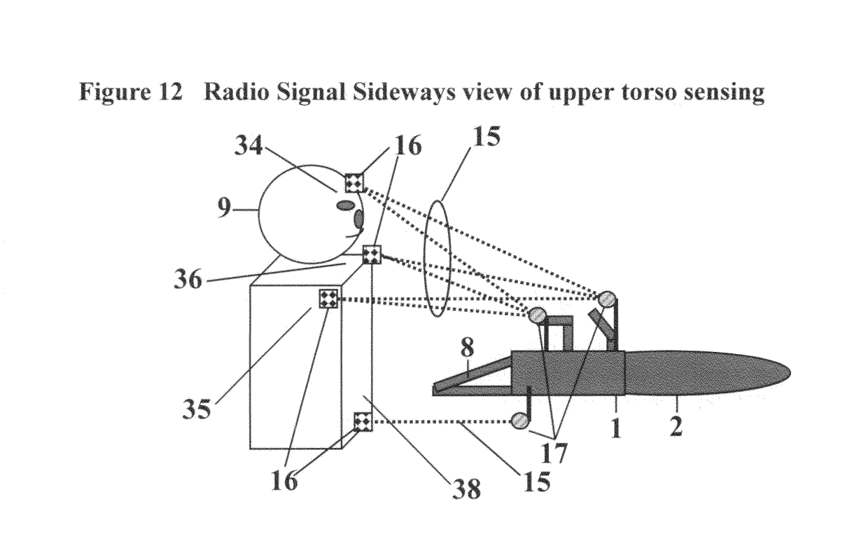

FIG. 12 shows a side view of Radio Signal Measurement sensing for the user torso of user 9 in relations to chainsaw 1. The Radio signal transmitters 17 emit radio signals 15 received by the receivers 16. The importance of this figure is the fact that there may be more than one transmitter and receiver and they may be mounted on various points on both the user 9 and the chainsaw 1. Each transmitter and receiver pair allows for monitoring the distance and changes in distance between the transmitter and receiver. As shown in the figure the transmitter/receiver configuration allows for the monitoring of distance and changes in distance (i.e. speed and acceleration) between the chainsaw 1 and the user 9 forehead 34, left shoulder 36, right shoulder 35 and lower chest/waist 38.

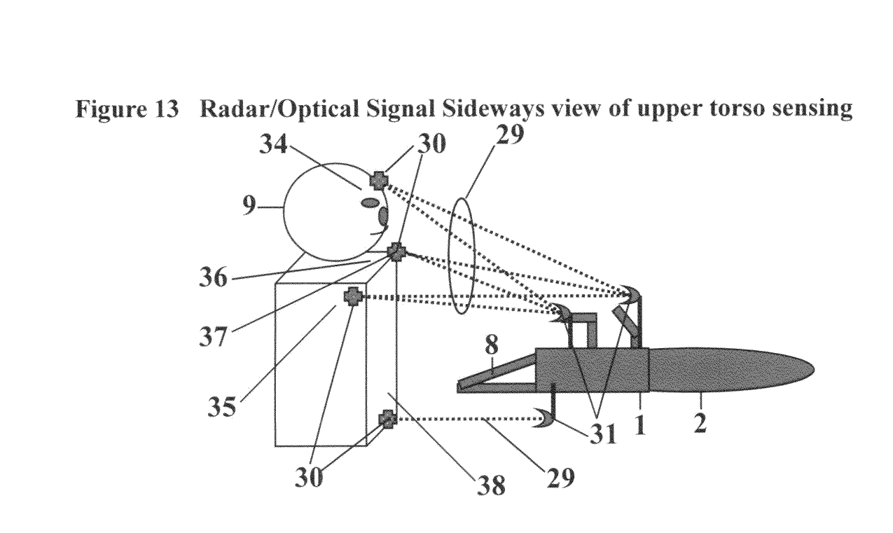

Similarly in FIG. 13 are shown a series of Optical and Radar transmitter/reflector pairs which allow for similar measurements as those described for FIG. 12 above. In FIG. 13 the transmitter and receiver modules are both within module 30 shown in the figure whereas in FIG. 12 above the transmitter and receiver are contained in separate physical modules. In FIG. 13 module 30 emits either an optical or radar signal 29 which is reflected off of reflector 31 and the reflected signal is returned to module 30.

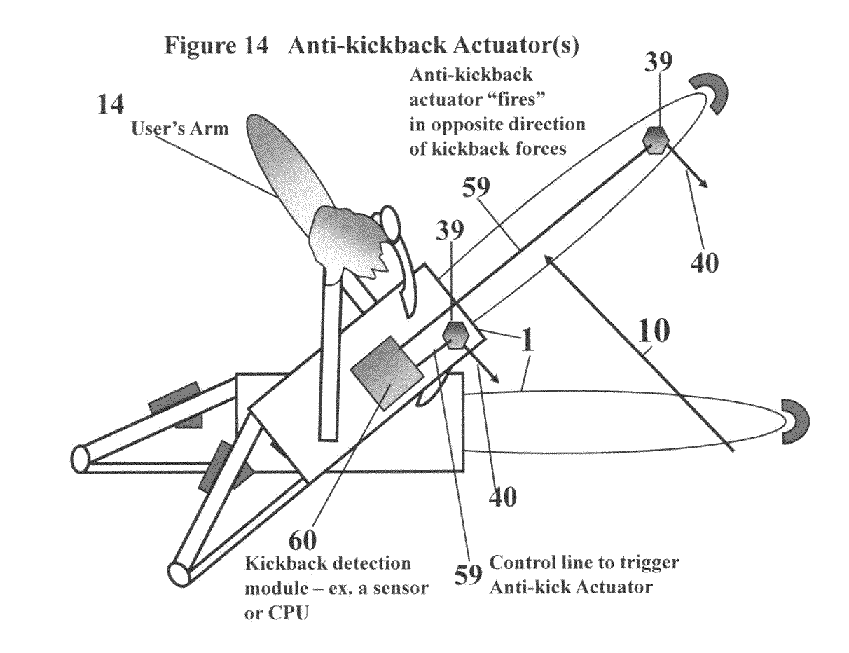

FIG. 14 describes the use of actuators to counter act dangerous chainsaw forces like kickback 10. Kickback 10 as previously described is when the chainsaw 1 forcibly comes back at its user possibly in an upward motion 10. Kickback can occur in many different ways and result in numerous different motions. FIG. 14 refers to one possible kickback scenario. When kickback is detected by some module 60 such as within a central processing unit (CPU), microcontroller or simply by a mechanical detection circuit a signal 59 can be sent to actuators 39 which caused them to actuate (i.e. move) very quickly. Much like the actuators atop skyscrapers which counteract the wind and weather related forces these actuators 39 would counteract dangerous forces 10 generated by chainsaw 1 use. It is important to note the direction of motion/force 10 in the figure and the opposite force or movement 40 caused by the actuators 39.

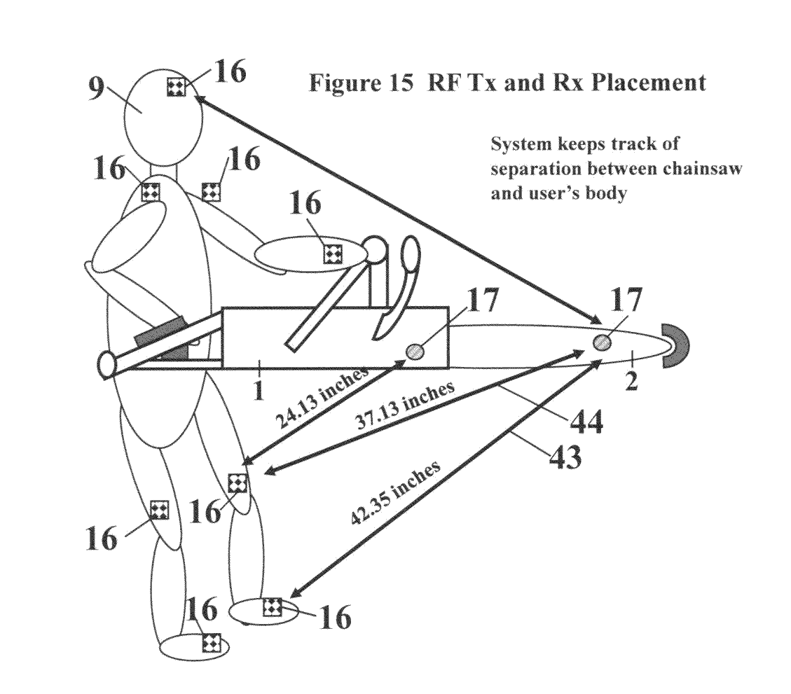

FIG. 15 elaborates on the concept of real time distance monitoring using the Radio signal transmitter 17 and receivers 16 mounted on a user 9 with associated signals 43 and 44. Important to note in this figure is the fact relative distances between the user 9 and the chainsaw 1 can be made for many parts of the user's 9 body. Signal 44 is used to determine a distance of 37.13 inches whereas signal 43 is used to measure a distance of 42.35 inches between relative points on the user 9 and the chainsaw 1.

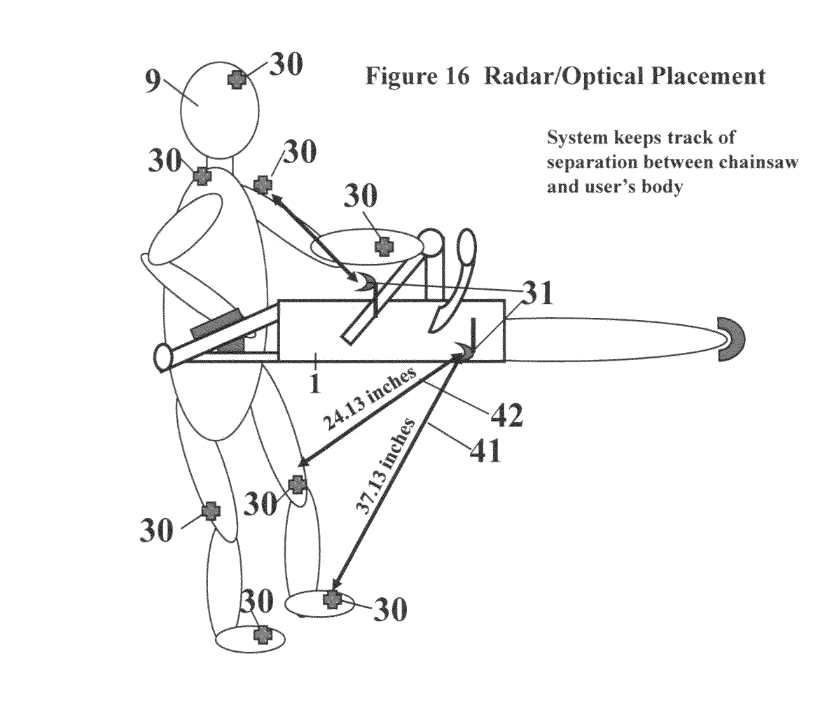

FIG. 16 shows distance measurement for a radar or optical signal configuration across many points on the user 9. In this case signal path 41 is used to determine a distance of 37.13 inches where as signal path 42 is used to determine a distance of 24.13 inches.

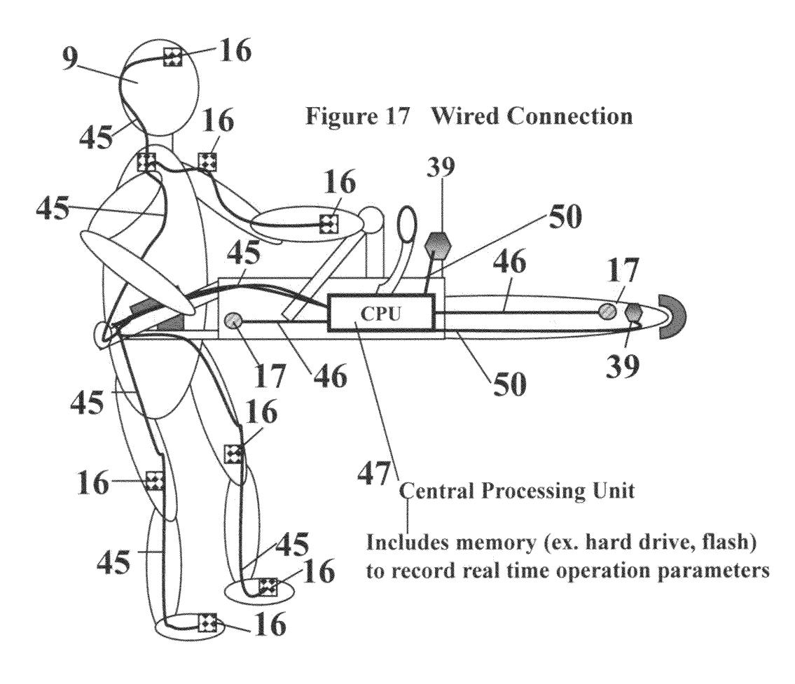

FIG. 17 shows how radio signal transmitter 17 and receivers might be “wired” to a central processing unit (CPU) 47 which includes some sort of memory for recording distance measurements, changes in distances as in speed and acceleration. The CPU can compare distance, speeds and acceleration measurements to predetermined thresholds and either record measurements periodically or upon detection of dangerous conditions. Shown also in the figure are anti-kickback actuators 39 which serve to counter-act the forces associated with kickback. CPU 47 detects a kickback situation, too close of operation to user (i.e. dangerous proximity) or other dangerous conditions and signals actuator 39 to quickly move the chainsaw via forces imparted by the actuator movement. If kickback is determined the actuators will “fire” or react in such a way as to cause an opposite force on the movement of the chainsaw 1. If the chainsaw 1 is accidentally to close to the user 9 the actuators 39 once again can be caused to “fire” by the CPU 47 but this time to cause the chainsaw 1 to move safely away from the user's body part it is too close to. Accelerometers are sensors that detect and measure movement (velocity and/or acceleration) could also be used for additional measurement. The CPU 47 communicates to the transmitter 17 via signal path 46 and to receivers 16 via signal paths/connections 45. Here again it is worthy to note the numerous receiver modules 16 which allow for numerous body monitoring points. The transmitter 17 and receiver pair 16 is referred to as a Radio Signal Measurement Module. It is important to note that one transmitter 17 can communicate and be associated with multiple receivers 16 and vice versa. The word module is used in an operation perspective rather than a purely physical perspective. The Radio Signal Measurement Module also includes the associated processing within CPU 47.

This invention effects earlier and more accurate sensing of chain saw kick back action and earlier actuation of the brake mechanism, by monitoring in real time the relative distances between the chainsaw and the user at multiple points.

FIG. 17, shows one of many possible placements on a chainsaw of transmitters 17 with a corresponding central processing unit (CPU) 47. On kick back, the transmitter 17/receiver 16 pair along with CPU 47 would undoubtedly quickly sense the abrupt upward angular movement of the free end of the bar and send signals to an electro-mechanical device such as a solenoid which would move the brake lever 6 forward to turn off the chain saw motor. Thus earlier actuation of the brake lever 6 is effected on kick back action of the chain saw, resulting in revolution of the endless chain 5 being halted before the chain saw contacts the user and cuts him.

Also shown in FIG. 17 where the central processing unit 47 and the electro-mechanical device move the brake lever 6 forward to turn off the chain saw motor, other aspects of the invention are also used to stop the cutting action of the chain saw in the event that the saw the cutting arm gets within predetermined hazardous distances from body parts of the user. To this end, the same transmitter and receiver pair along with the CPU very quickly and accurately determine the distance of the cutting chain from any physical part of the user. As the saw gets within a predetermined hazardous distance off a body-resident receiver 16, it emits signals to discontinue movement of the cutting endless chain. The signal processor 47 mounted on the chain saw receives the signals of hazardous closeness(s) and signals an electro-mechanical device to apply the proper electrical and/or mechanical measures to discontinue movement of the cutting endless chain. Discontinuance of the cutting endless-chain movement may be by electrical circuit opening, de-clutching and/or braking operations. The CPU would perform the necessary real-time signal processing activities.

A wireless-connected array of sensors, transmitters and receivers is an alternative, or could be used in conjunction with wired devices.

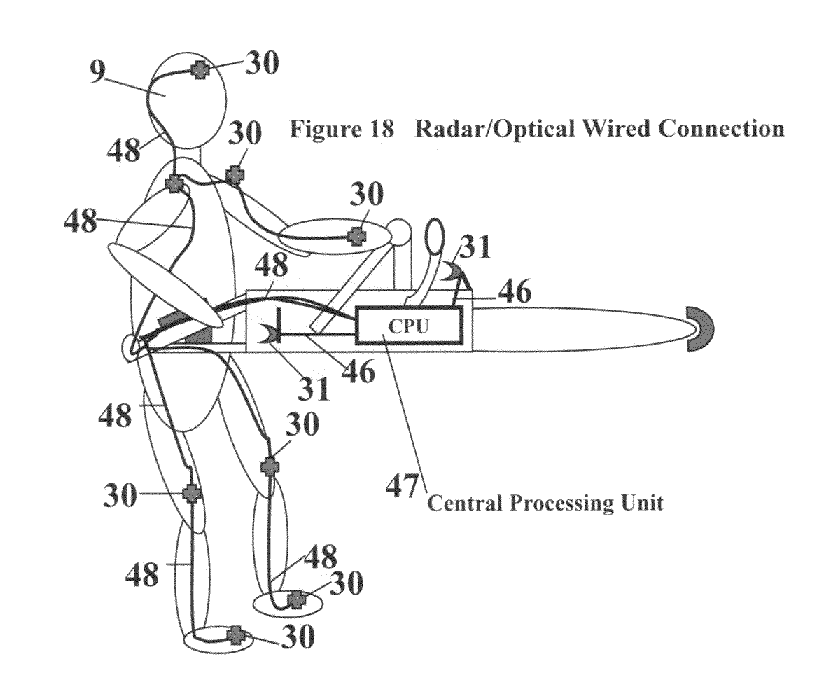

In FIG. 18 is shown a CPU 47 communicating via signals 48 to radar transmitter/receiver modules 30. In this figure we refer to the association of a transmitter/receiver module 30 and a reflector 31 as a Radar Signal Measurement Module or when optical signals are used in place of radar ones an Optical Signal Measurement Module. These modules include the associated processing within the CPU 47. A wireless-connected array of sensors, transmitters and receivers is an alternative, or could be used in conjunction with wired devices.

The chain saw bar-mounted accelerometers, transmitters and other sensors must be of such size and shape as not to interfere with the operation of the chainsaw itself. The width of the device and the bar or arm must be less than the width of the endless chain cutting elements themselves. The sensors when mounted on the cutting arm must also be integrated with the bar or arm in such a way so that they do not get hung up on the object being cut. There must be a smooth transition from arm to the top edge of accelerometer, sensor or device and back down to the arm surface. If a sensor is physically (i.e. instead of wireless) connected to the processor, any wiring must of course, be protected (enclosed).

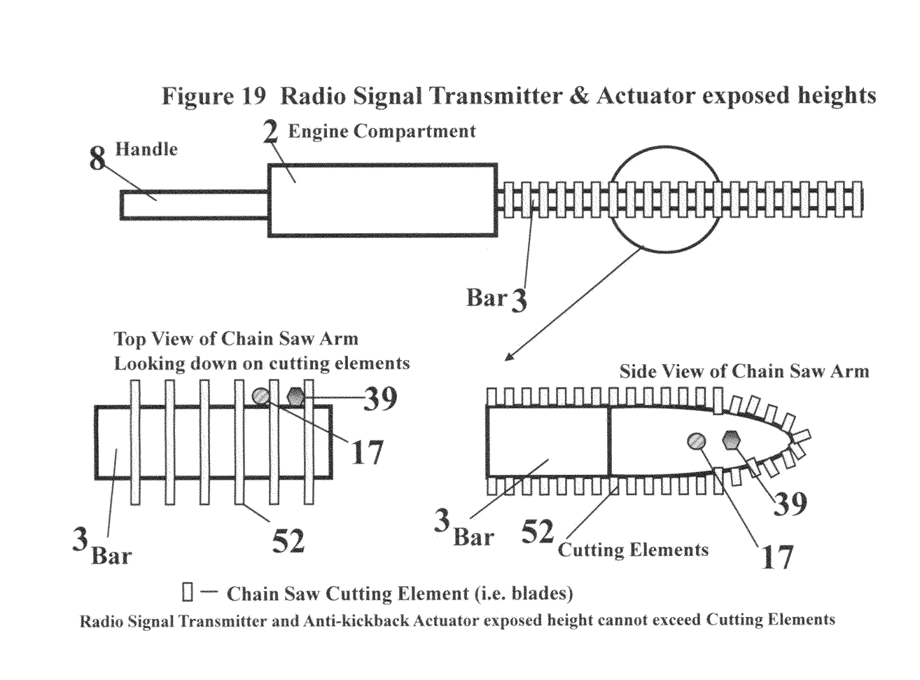

Several views of the chainsaw cutting elements 52 relationships to the chainsaw, are shown in FIG. 19. Anti-kickback actuators 39 and radio signal transmitters 17 placed on or within the chain saw bar, do not interfere with the standard operation of the unit. The devices 39 and 17 do not protrude from the side of the bar 3 with a width such that they might get hung up on the material being cut.

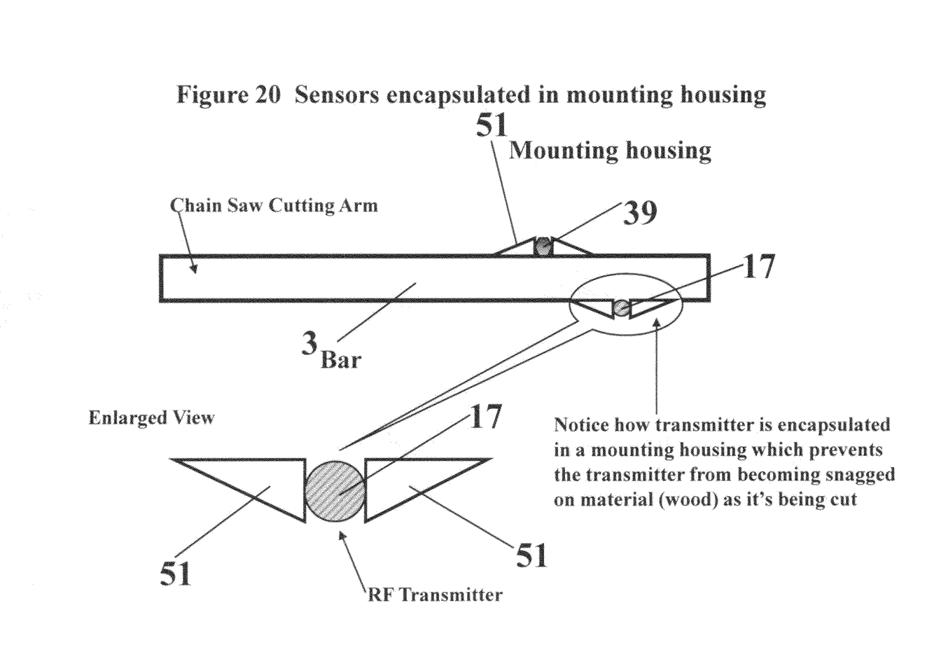

FIG. 20, depicts encapsulation of the anti-kickback actuator 39 and transmitter 17 in an encasement 51 which provides inclined slopes protecting the anti-kickback actuator 39 and transmitter 17 in a graduated expansion of the bar 3 surface. The mounting housing 51 secures the anti-kickback actuator 39 and transmitter 17 to the bar 3, and provides such a graduated width change.

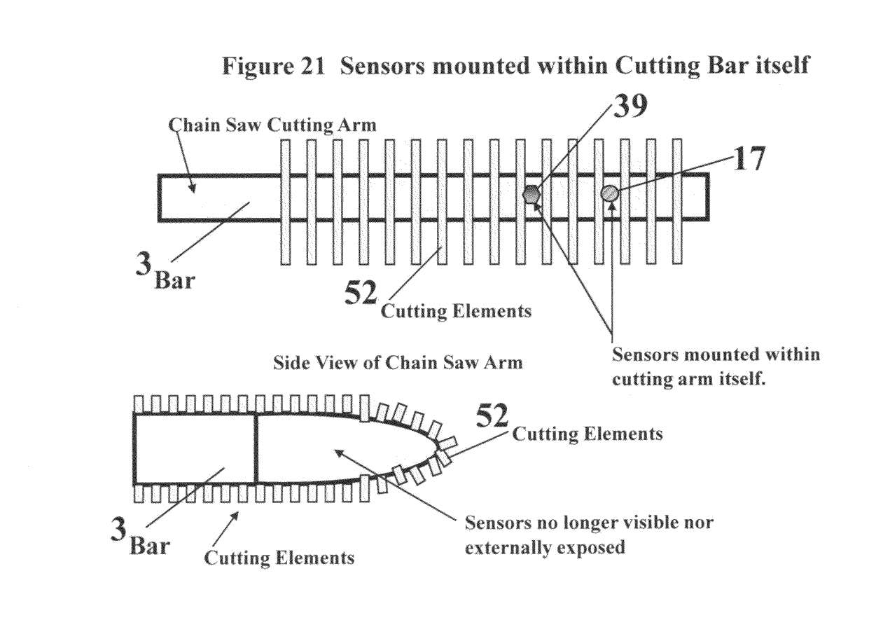

In FIG. 21, anti-kickback actuator 39 and transmitter 17 are shown mounted within the bar 3 itself, care being taken not to interrupt the signal transmission from and detection paths to the anti-kickback actuator 39 as by covering them with a wave permeable material.

As noted above, with distance measurement is made between two points. Should some sort of object come into place between the pair of measurement points, the measurement might possibly be incorrect. If an object interrupts a measurement, the CPU checks the measurements of the other sensors of the array to intelligently determine the chainsaw proximity and dynamics. Thus the proximity measurements are interpreted independently as well as interdependently.

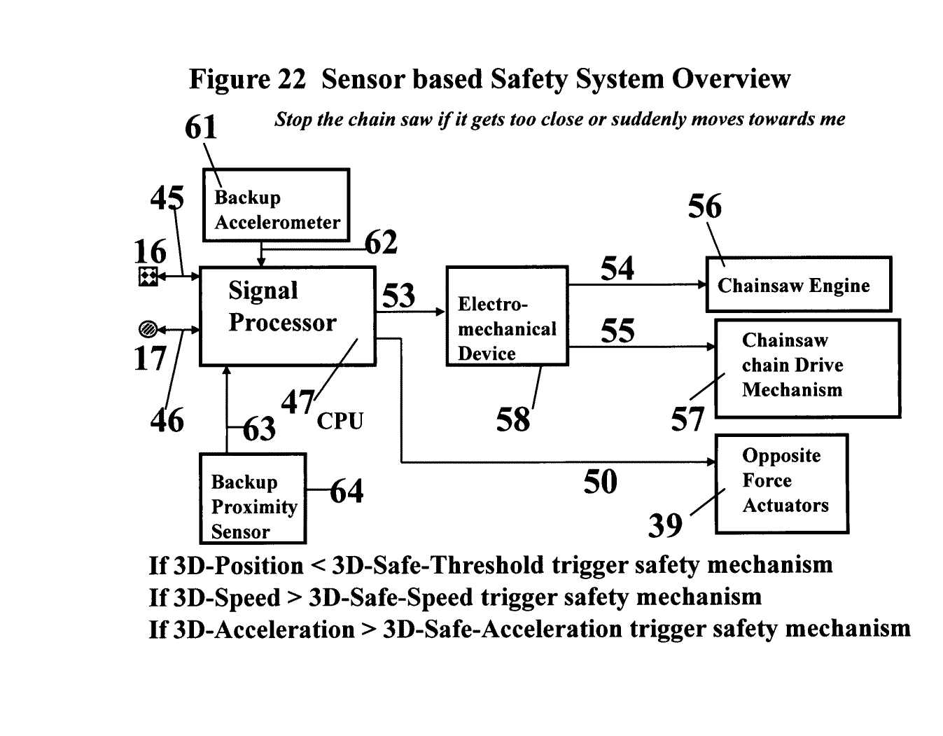

FIG. 22 provides the reader with an overview of the invention. The system may consist of an array of radio signal transmitters 17 driven by CPU 47 via signals 46, receivers 16 which send signals 45 to CPU 47, a signal processor/central processing unit 47, an electro-mechanical device 58 which connects to the chain saw engine 56 via signal 54 and the chain saw drive mechanism 57 via signal 55, and backup accelerometers 61 which deliver measurement signals 62 to the CPU47, backup proximity sensors 64 delivering proximity measurements to the CPU 47, and finally anti-kickback (Opposite Force) actuators 39 driven by signals 50 from the CPU 47. The electro-mechanical device acts as the interface to the chain saw itself to invoke the proper interruption of operation should the apparatus detect a dangerous situation. While FIG. 22 shows components at a conceptual level, the actual physical hardware arrangement may vary, especially since technology often incorporates or integrates much functionality within single integrated-circuitry (IC) chips.

Also shown in FIG. 22 are the concepts that the CPU 47 monitors the three dimensional (3D) position of the chainsaw in relation to its user and if it exceeds the threshold—in other words comes too close to the user the safety measures are engaged. By knowing the physical properties of the chainsaw and the exact points from which measurements are made from the chainsaw the CPU can very precisely know where a given point on the chainsaw is in regards to the user. Likewise the three dimensional angular speed and acceleration are determined by the CPU 47 using measurements made and these numbers are compared to predetermined thresholds which if exceeded the CPU will trigger/engage safety measures—meaning the CPU 47 will signal the actuators 39, and the Electromechanical Device 58.

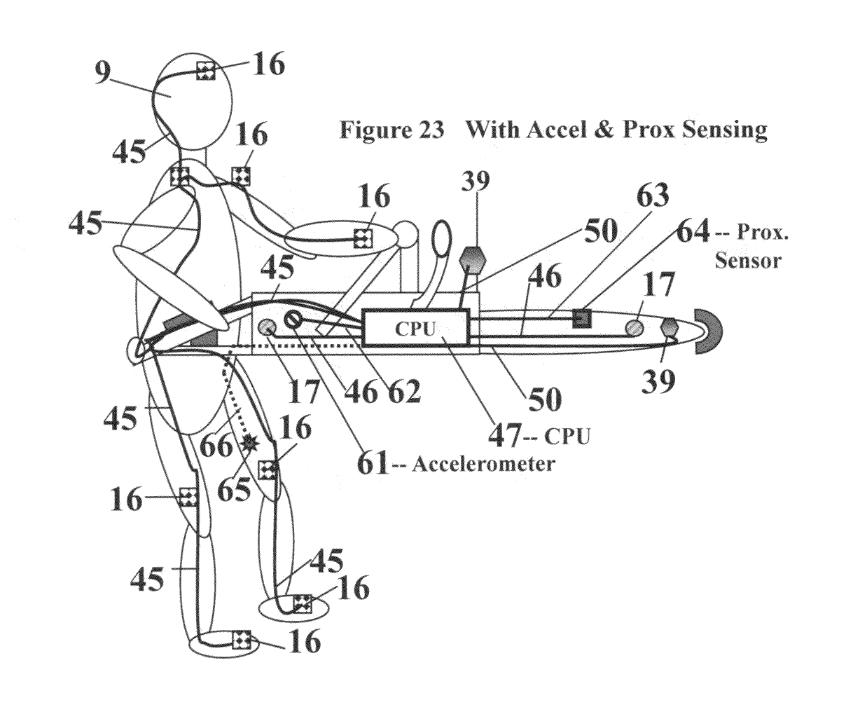

FIG. 23 shows another physical view of the invention in the “wired” configuration where devices communicate with the CPU 47 via signals/wires 45, 46, 62, 50 and 63. Shown in the figure are accelerometers 61 which provide acceleration and speed measurements via signals 62 to the CPU 47. These accelerometers are a backup means of determining relative movement of the chainsaw 1 in relations to the user 9. The primary means of measurement of position, acceleration and speed of the chainsaw 1 in relations to the user 9 is as mentioned prior the Radio Signal transmitter 17 and receiver 16 pairs. Shown also are the opposite force actuators 39 and the proximity sensor 64.

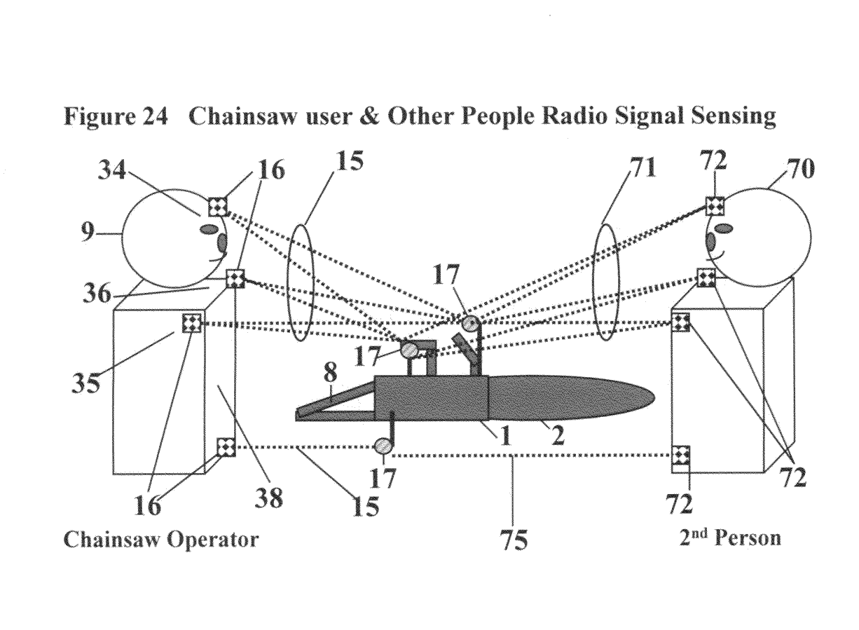

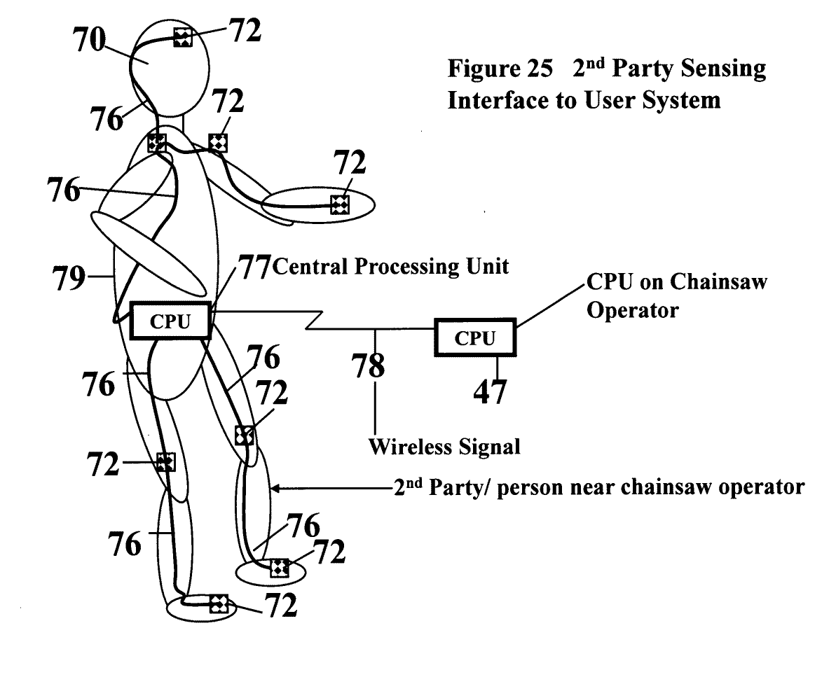

The last two FIGS. 24 and 25 introduce the concept of protecting another person 70 whom might be assisting the chainsaw user 9 from being impacted or hurt by the chainsaw 1. As shown in FIG. 24 this second person 70 is not operating the chainsaw 1 but they are in close proximity to the chainsaw 1 and the user 9 of that chainsaw 1. They might be removing branches or other material cut by the chainsaw user. As shown in the figure there are Radio Signal Receivers 72 mounted on various body part of the second person 70 which receive signals from the transmitters 17 and then send via wireless signals information and data back to the CPU 47 which monitors how close the chainsaw 1 is to the second person 70.

FIG. 25 shows how a number of Radio Signal Receivers 72 mounted on the second person 70 interface via signals 76 with a CPU 77 which transmits and communicates with the chainsaw user's CPU 47 via a wireless connection 78. Of course there could be a wired connection between the two CPU but operationally the best would be a wireless connection. CPU 77 relays measurement data back to CPU 47.

Hardware as well as software solutions that implement these algorithms are commonly available. The adaptive signal processing algorithms used for sensor array processing and thresholding are well documented. Signal extraction and processing is old, and the associated mathematical algorithms are well documented and used in quite a few products in industry.

In today's technology:

Multidimensional signal extraction and processing algorithms exist

Radio Signal Measurement Modules and techniques exist

Optical Signal Measurement Modules and techniques exist

Radar Signal Measurement Modules and techniques exist

Actuators exist

Sensors exist;

Processor speeds are sufficient, particularly if the algorithm is simple as in measurement and threshold operations; dedicated devices could be used if very complex algorithms are needed in particular situations. And processor speeds are ever increasing.

While applicants have shown and described preferred embodiments of the invention, it will be apparent to those skilled in the art that other and different applications may be made of the principles of the invention. It is desired therefore to be limited only by the scope or spirit of the appended claims.

What is claimed is:

1. A safer power-driven cutting machine, comprising a bar, a motor mounted on said bar, a movable cutting apparatus mounted on said bar and driven by said motor, and safety apparatus for controlling movement of said cutting apparatus upon it sensing a certain change in the disposition of the bar.

2. A safer power-driven cutting machine according to claim 1, wherein the safety apparatus for controlling movement of said cutting apparatus upon sensing a certain change in the disposition of the bar also senses another change in the disposition of the bar.

3. A safer power-driven cutting machine according to claim 1, wherein the safety apparatus for controlling movement of said cutting apparatus upon a certain change in the disposition of the bar does so by turning off the motor

4. A safer power-driven cutting machine according to claim 1, wherein the safety apparatus for controlling movement of said cutting apparatus upon sensing a certain change in the disposition of the bar does so by causing the cutting apparatus to stop.

5. A safer power-driven cutting machine according to claim 1, wherein the safety apparatus for controlling movement of said cutting apparatus upon sensing a certain change in the disposition of the bar does so by causing a opposite force actuator to engage.

6. A safer power-driven cutting machine according to claim 5, wherein the safety apparatus for controlling movement of said cutting apparatus upon sensing a certain change in the disposition of the bar does so by causing additional opposite force actuators to engage.

7. A safer power-driven cutting machine, comprising a bar, a motor mounted on said bar, a movable cutting apparatus mounted on said bar and driven by said motor, and safety apparatus for controlling movement of said cutting machine upon it sensing a certain change in the disposition of the bar.

8. A safer power-driven cutting machine according to claim 7, wherein the safety apparatus for controlling movement of said cutting machine upon sensing a certain change in the disposition of the bar does so by causing a opposite force actuator to engage.

9. A safer power-driven cutting machine according to claim 8, wherein the safety apparatus for controlling movement of said cutting machine upon sensing a certain change in the disposition of the bar does so by causing a opposite force actuator to engage as well as causing the cutting apparatus to stop.

10. A safer power-driven cutting machine according to claim 1, wherein the certain change in the disposition of the bar which the safety apparatus for controlling movement of said cutting apparatus senses is an abrupt movement of the bar.

11. A safer power-driven cutting machine according to claim 10, wherein the safety apparatus for controlling movement of said cutting apparatus upon an abrupt movement of the bar includes a Radio Signal Distance Measurement Module.

12. A safer power-driven cutting machine according to claim 11, wherein the safety apparatus for controlling movement of said cutting apparatus upon an abrupt movement of the bar includes additional Radio Signal Distance Measurement Modules.

13. A safer power-driven cutting machine according to claim 1, wherein the certain change in the disposition of the bar which the safety apparatus for controlling movement of said cutting apparatus senses is a change in the relationship of the bar to a user thereof.

14. A safer power-driven cutting machine according to claim 13, wherein the certain change in the relationship of the bar to a user thereof is the bar moving within a predetermined hazardous distance of a body part of the user.

15. A safer power-driven cutting machine according to claim 14, wherein safety apparatus for controlling movement of said cutting apparatus upon the bar moving within a predetermined hazardous distance of a body part of the user includes a Radio Signal Distance Measurement Module.

16. A safer power-driven cutting machine according to claim 15 includes additional Radio Signal Distance Measurement Modules.

17. A safer power-driven cutting machine according to claim 1, wherein the certain change in the disposition of the bar which the safety apparatus for controlling movement of said cutting apparatus senses is an abrupt movement of the bar and a change in the relationship of the bar to a user thereof.

18. A safer power-driven cutting machine according to claim 17, wherein safety apparatus for controlling movement of said cutting apparatus upon the bar moving within a predetermined hazardous distance of a body part of the user and upon an abrupt movement of the bar includes a Radio Signal Distance Measurement Module.

19. A safer power-driven cutting machine according to claim 10, wherein the safety apparatus for controlling movement of said cutting apparatus upon an abrupt movement of the bar includes an Optical Signal Distance Measurement Module.

20. A safer power-driven cutting machine according to claim 14, wherein safety apparatus for controlling movement of said cutting apparatus upon the bar moving within a predetermined hazardous distance of a body part of the user includes an Optical Signal Distance Measurement Module.

21. A safer power-driven cutting machine according to claim 17, wherein safety apparatus for controlling movement of said cutting apparatus upon the bar moving within a predetermined hazardous distance of a body part of the user and upon an abrupt movement of the bar includes an Optical Signal Distance Measurement Module.

22. A safer power-driven cutting machine according to claim 10, wherein the safety apparatus for controlling movement of said cutting apparatus upon an abrupt movement of the bar includes a Radar Signal Distance Measurement Module.

23. A safer power-driven cutting machine according to claim 14, wherein safety apparatus for controlling movement of said cutting apparatus upon the bar moving within a predetermined hazardous distance of a body part of the user includes a Radar Signal Distance Measurement Module.

24. A safer power-driven cutting machine according to claim 17, wherein safety apparatus for controlling movement of said cutting apparatus upon the bar moving within a predetermined hazardous distance of a body part of the user and upon an abrupt movement of the bar includes a Radar Signal Distance Measurement Module.

25. A safer power-driven cutting machine according to claim 1, wherein safety apparatus for controlling movement of said cutting apparatus includes a means to record relative distances between sensing components, as well as the angular speed and acceleration of said cutting machine.

26. A safer power-driven cutting machine according to claim 1, wherein safety apparatus for controlling movement of said cutting apparatus includes an accelerometer to sense movements of said cutting apparatus.

27. A safer power-driven cutting machine according to claim 1, wherein safety apparatus for controlling movement of said cutting apparatus includes a proximity sensor to sense relative distances between said cutting apparatus the cutting machine user.

28. A safer power-driven cutting machine according to claim 1, wherein the safety apparatus for controlling movement of said cutting apparatus includes a central processing unit receiving signals from the Radio Signal Measurement Modules and processing them to control the movement of said cutting apparatus.

29. A safer power-driven cutting machine according to claim 1, wherein the safety apparatus for controlling movement of said cutting apparatus includes a central processing unit receiving signals from the Optical Signal Measurement Modules and processing them to control the movement of said cutting apparatus

30. A safer power-driven cutting machine according to claim 1, wherein the safety apparatus for controlling movement of said cutting apparatus includes a central processing unit receiving signals from the Radar Signal Measurement Modules and processing them to control the movement of said cutting apparatus.

31. A safer power-driven cutting machine according to claim 1, wherein the safety apparatus for controlling movement of said cutting apparatus includes a secondary set of Radio Signal Measurement Modules to monitor and control the movement of said cutting apparatus in relation to a person not operating the cutting device.

32. A safer power-driven cutting machine according to claim 1, wherein the safety apparatus for controlling movement of said cutting apparatus includes a secondary set of Optical Signal Measurement Modules to monitor and control the movement of said cutting apparatus in relation to a person not operating the cutting device.

33. A safer power-driven cutting machine according to claim 1, wherein the safety apparatus for controlling movement of said cutting apparatus includes a secondary set of Radar Signal Measurement Modules to monitor and control the movement of said cutting apparatus in relation to a person not operating the cutting device.

34. A method of operating a safer power-driven cutting machine having a bar, a motor mounted on said bar, and a movable cutting apparatus mounted on said bar and driven by said motor; comprising the steps of turning on said motor to drive the cutting apparatus, and automatically controlling the movement of said cutting apparatus by sensing a certain change in the disposition of the bar.

35. A measurement safety system having a cutting device and a power and/or drive mechanism for the cutting device; comprising Radio Signal Measurement Modules for detecting distance and movement measurements; an electro-mechanical interface with the power and/or drive mechanism of the cutting device; and a signal processor receiving input from the modules, processing and validating said signals, determining distance and movement measurements, comparing the measurements to preset thresholds, and providing output to the cutting device by way of the electro-mechanical interface.

36. A measurement safety system having a cutting device and a power and/or drive mechanism for the cutting device; comprising Radio Signal Measurement Modules for detecting distance and movement measurements; an electro-mechanical interface with the power and/or drive mechanism of the cutting device; and a signal processor receiving input from the modules, processing and validating said signals, determining distance and movement measurements, comparing the measurements to preset thresholds, and providing output to opposite force actuators.

37. A motion and proximity measurement safety system having a cutting device and a power and/or drive mechanism for the cutting device according to claim 2, wherein the cutting device has a cutting arm, wherein sensors are mounted within a graduated edge housing on the arm while still exposing the sensing portion of said sensor to reduce the vulnerability of the sensor to dislodgment and the device operation to obstruction.
